(19) United States
(12) Patent Application Publication
(10) Pub. No.: US 2020/0358140 A1
(43) Pub. Date: Nov. 12, 2020

(54) ELECTRONIC COMPONENT MOUNTING SUBSTRATE, BATTERY PACK, AND ELECTRONIC DEVICE

(71) Applicant: MURATA MANUFACTURING CO., LTD., Kyoto (JP)

(72) Inventor: Yasushi MORI, Kyoto (JP)

(21) Appl. No.: 16/943,586

(22) Filed: Jul. 30, 2020

Related U.S. Application Data
(63) Continuation of application No. PCT/JP2019/004236, filed on Feb. 6, 2019.

(30) Foreign Application Priority Data
Feb. 9, 2018 (JP) 2018-022323

(51) Int. Cl. H01M 10/42; H01M 2/02; H01M 2/22

(52) U.S. Cl. CPC H01M 10/425; G06F 1/163; H01M 2/22; H01M 2/028

(57) ABSTRACT

An electronic component mounting substrate includes: a substrate having a first substrate terminal, a second substrate terminal, and an insulator provided between the first substrate terminal and the second substrate terminal; and an electronic component having a first terminal configured to be connected to the first substrate terminal and a second terminal configured to be connected to the second substrate terminal, the electronic component being provided on the insulator. The insulator is provided on a surface of the substrate and has a protrusion configured to protrude from peripheral portions between the first terminal and the second terminal on a periphery of the electronic component. A length x of the protrusion of the insulator from each of the peripheral portions and a length a of the electronic component in a direction from the first terminal toward the second terminal satisfy a relationship of x≥a/4.

### CROSS REFERENCE TO RELATED APPLICATIONS

The present application is a continuation of PCT patent application no. PCT/JP2019/004236, filed on Feb. 6, 2019, which claims priority to Japanese patent application no. JP2018-022323 filed on Feb. 9, 2018, the entire contents of which are being incorporated herein by reference.

### BACKGROUND

The present technology generally relates to an electronic component mounting substrate, a battery pack, and an electronic device.

There have been proposed various electronic component mounting substrates on which electronic components are mounted on a substrate.

### SUMMARY

The present technology generally relates to an electronic component mounting substrate, a battery pack, and an electronic device.

However, in the conventional technology when a water droplet adheres to a peripheral portion of an electronic component under a high-temperature and high-humidity atmosphere or due to dew condensation or the like, the water droplet may connect between the electrodes, between the electrode pads, or the like, depending on the size of the water droplet, and electric corrosion may occur.

It is an object of the present invention to provide an electronic component mounting substrate, and a battery pack and an electronic device including the same, which can prevent the occurrence of electric corrosion even when a water droplet adheres to a peripheral portion of an electronic component.

According to an embodiment of the present technology, an electronic component mounting substrate is provided. The electronic component mounting substrate includes a substrate having a first substrate terminal, a second substrate terminal, and an insulator provided between the first substrate terminal and the second substrate terminal; and an electronic component having a first terminal configured to be connected to the first substrate terminal and a second terminal configured to be connected to the second substrate terminal, the electronic component being provided on the insulator. The insulator is provided on a surface of the substrate and has a convex shape with respect to the surface of the substrate, and the insulator has a protrusion configured to protrude from peripheral portions between the first terminal and the second terminal on a periphery of the electronic component. A length x of the protrusion of the insulator from each of the peripheral portions and a length a of the electronic component in a direction from the first terminal toward the second terminal satisfy a relationship of x≥a/4.

According to the above configuration, since the length x of the protrusion of the insulator and the length a of the electronic component satisfy the relationship of x≥a/4, the length x of the protrusion of the insulator becomes equal to or greater than the height of the water droplet even when the water droplet adheres to the peripheral portion of the electronic component under a high-temperature and high-humidity atmosphere or due to dew condensation or the like. As a result, it is possible to prevent the water droplet from connecting between the first terminal and the second terminal or between the first substrate terminal and the second substrate terminal. It is thus possible to prevent the occurrence of electric corrosion.

According to an embodiment of the present technology, the electronic component may be an all-solid-state battery. According to the above configuration, it is possible to prevent the electric corrosion of the all-solid-state battery.

According to an embodiment of the present technology, it is preferable that the substrate include a first solder that solders the first terminal to the first substrate terminal, and a second solder that solders the second terminal to the second substrate terminal, and a width w of the insulator 23 satisfy a relationship of the following formula (1):

w≤2×(a/c)×((c/2)−b) (1)

where a is a length of the electronic component in the direction from the first terminal toward the second terminal, b is a thickness of the insulator 23, and c is a thickness of each of the first solder and the second solder before reflow.

According to the above configuration, even when the electronic component is placed with an inclination to the surface of the substrate due to the insulator, the contact between the first terminal and the first solder and the contact between the second terminal and the second solder can be ensured. It is thus possible to prevent the occurrence of a soldering failure.

According to an embodiment of the present technology, it is preferable that the substrate have a plurality of the first substrate terminals, and a plurality of the second substrate terminals, a plurality of the electronic components be provided on the insulator such that the peripheral portions face each other, and the insulator has an extended portion extended in the direction from the first terminal toward the second terminal, and the extended portion is between the electronic components adjacent to each other. According to the above configuration, even when the water droplet adheres to the peripheral portion of the electronic component under a high-temperature and high-humidity atmosphere or due to dew condensation or the like, it is possible to prevent the water droplet from connecting between the adjacent electronic components. It is thus possible to prevent the occurrence of electric corrosion.

According to an embodiment of the present technology, an electronic component mounting substrate is provided. The electronic component mounting substrate includes a substrate having a first substrate terminal, a second substrate terminal, and an insulator provided between the first substrate terminal and the second substrate terminal; and an electronic component having a first terminal configured to be connected to the first substrate terminal and a second terminal configured to be connected to the second substrate terminal, the electronic component being provided on the insulator. The insulator is provided on a surface of the substrate and has a convex shape with respect to the surface of the substrate, and the insulator has a protrusion configured to protrude from peripheral portions between the first terminal and the second terminal on a periphery of the electronic component. A length x of the protrusion of the insulator from each of the peripheral portions and a distance y satisfy a relationship of x≥y/2. The distance y is a longer distance between a distance from a first end of the peripheral portion to a position of the protrusion of the insulator and a distance from a second end of the peripheral portion to the position of the protrusion of the insulator.

According to the above configuration, since the length x of the protrusion of the insulator and the length a of the electronic component satisfy the relationship of x≥y/2, the length x of the protrusion of the insulator becomes equal to or greater than the height of the water droplet even when the water droplet adheres to the peripheral portion of the electronic component under a high-temperature and high-humidity atmosphere or due to dew condensation or the like. As a result, it is possible to prevent the water droplet from connecting between the first terminal and the second terminal or between the first substrate terminal and the second substrate terminal. It is thus possible to prevent the occurrence of electric corrosion.

According to an embodiment of the present technology, a battery pack is provided. The battery pack includes the electronic component mounting substrate according to the embodiments as described herein.

According to an embodiment of the present technology, an electronic device is provided. The electronic device includes the electronic component mounting substrate according to the embodiments as described herein.

According to an embodiment of the present technology, an electric vehicle is provided. The electric vehicle includes the electronic component mounting substrate according to the embodiments as described herein.

According to the present invention, even when a water droplet adheres to the peripheral portion of the electronic component, electric corrosion can occur. The effects described herein are not necessarily limited but may be any of effects described in the present invention or effects different from those.

### BRIEF DESCRIPTION OF THE FIGURES

FIG. 1 is an exploded perspective view illustrating a configuration of a battery pack according to an embodiment of the present technology.

FIG. 2A is a plan view illustrating a configuration of an electronic component mounting substrate according to an embodiment of the present technology. FIG. 2B is a sectional view taken along line IIB-IIB of FIG. 2A.

FIG. 3A is an enlarged plan view illustrating an instance in which a contact angle of a water droplet on the side surface of the battery is 90°. FIG. 3B is an enlarged plan view illustrating an instance in which the contact angle of the water droplet on the side surface of the battery is 180°.

FIG. 4A is a side view illustrating the electronic component mounting substrate in a state where no soldering failure has occurred. FIG. 4B is a side view illustrating the electronic component mounting substrate in a state where a soldering failure has occurred. FIG. 4C is a side view of the electronic component mounting substrate for explaining a condition on which no soldering failure occurs.

FIG. 5 is a sectional view illustrating a configuration of a battery according to an embodiment of the present technology.

FIG. 6 is a circuit diagram illustrating a circuit configuration of the electronic component mounting substrate according to an embodiment of the present technology.

FIGS. 7A and 7B are plan views each illustrating a modification of the electronic component mounting substrate. according to an embodiment of the present technology

FIGS. 8A and 8B are plan views each illustrating a modification of the electronic component mounting substrate according to an embodiment of the present technology.

FIG. 9 is an enlarged plan view illustrating a modification of the electronic component mounting substrate according to an embodiment of the present technology.

FIG. 10 is a perspective view illustrating the appearance of a wristband electronic device as an application according to an embodiment of the present technology.

FIG. 11 is a block diagram illustrating the configuration of the wristband electronic device as the application according to an embodiment of the present technology.

FIG. 12 is a schematic diagram illustrating a configuration of a hybrid vehicle as an application.

FIG. 13 is a schematic diagram illustrating a configuration of a power storage system as an application according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

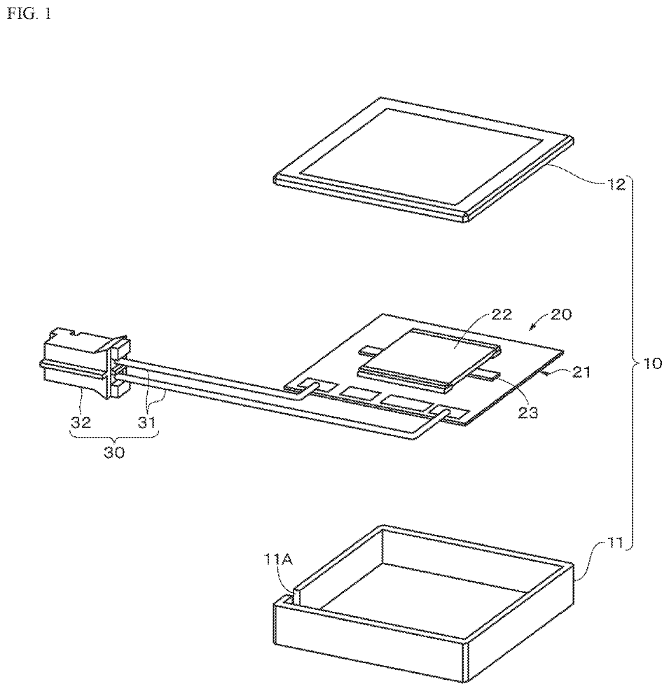

As illustrated in FIG. 1, a battery pack according to one embodiment of the present invention includes an exterior case 10, an electronic component mounting substrate 20 housed in the exterior case 10, and a cable connector 30 connected to the electronic component mounting substrate 20.

The exterior case 10 includes a case body 11 having a thin box shape with one main surface opened, and a lid 12 provided so as to block the opened one main surface. The case body 11 has a hole 11A in a peripheral wall, and the cable connector 30 is led out from the hole 11A. The exterior case 10 is made of, for example, a polymer resin or a metal.

The cable connector 30 includes a cable 31 and a connector 32 provided at one end of the cable 31. The other end of the cable 31 is connected to the electronic component mounting substrate 20. The connector 32 is configured to be connectable to an electronic device or the like.

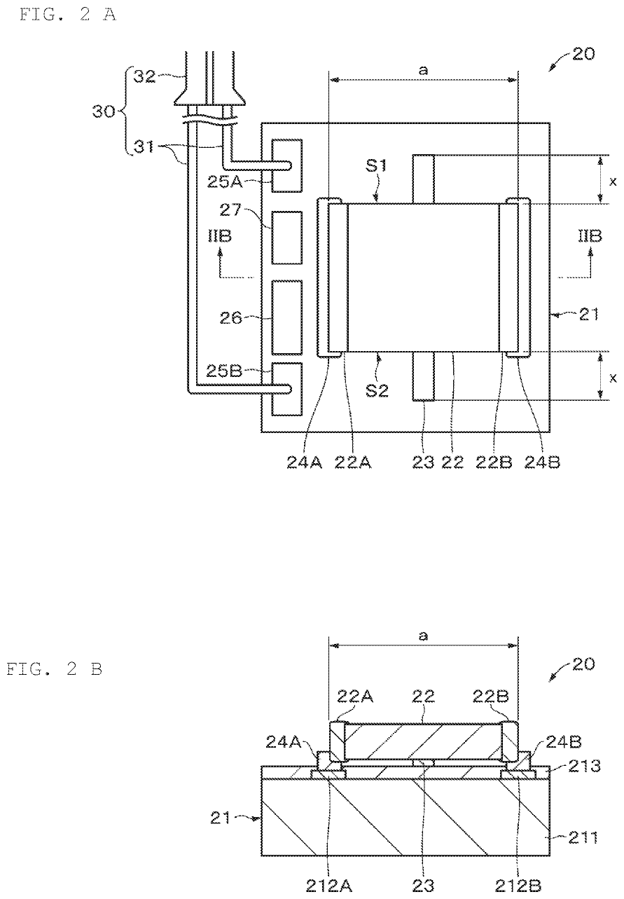

The electronic component mounting substrate 20 includes a flat printed circuit board (Hereinafter referred to simply as “substrate”) 21 and a rectangular thin plate-shaped battery 22 provided on one surface of the substrate 21. As illustrated in FIGS. 2A and 2B, the substrate 21 includes a substrate body 211, pads (first and second substrate terminals) 212A, 212B provided on one surface of the substrate body 211, a resist layer (protective layer) 213 provided so as to cover the one surface of the substrate body 211, and an insulator 23 provided between the pads 212A, 212B on the surface of the resist layer 213. The battery 22 has a positive electrode terminal (first terminal) 22A and a negative electrode terminal (second terminal) 22B connected to the pads 212A, 212B, respectively, and is provided on the insulator 23.

On the one surface of the substrate body 211, in addition to the pads 212A, 212B, solders 24A, 24B, a plus terminal 25A, a minus terminal 25B, a protection integrated circuits: integrated circuit (IC) 26, and a charge/discharge field-effect transistor (FET) 27 are provided.

The insulator 23 has a convex shape with respect to the one surface of the substrate 21. When the electronic component mounting substrate 20 is seen in a plan view from a direction perpendicular to the one surface on which the battery 22 is mounted, the insulator 23 has a linear shape and has both ends protruding perpendicularly to both side surfaces (peripheral portion) S1, S2 between the positive electrode terminal 22A and the negative electrode terminal 22B. The protruding position of the insulator 23 is the center position of the side surfaces S1, S2. A length x of the protrusion of the insulator 23 from each of the portions of the side surfaces S1, S2 and a length a of the battery 22 in a direction from the positive electrode terminal 22A toward the negative electrode terminal 22B satisfy a relationship of x≥a/4.

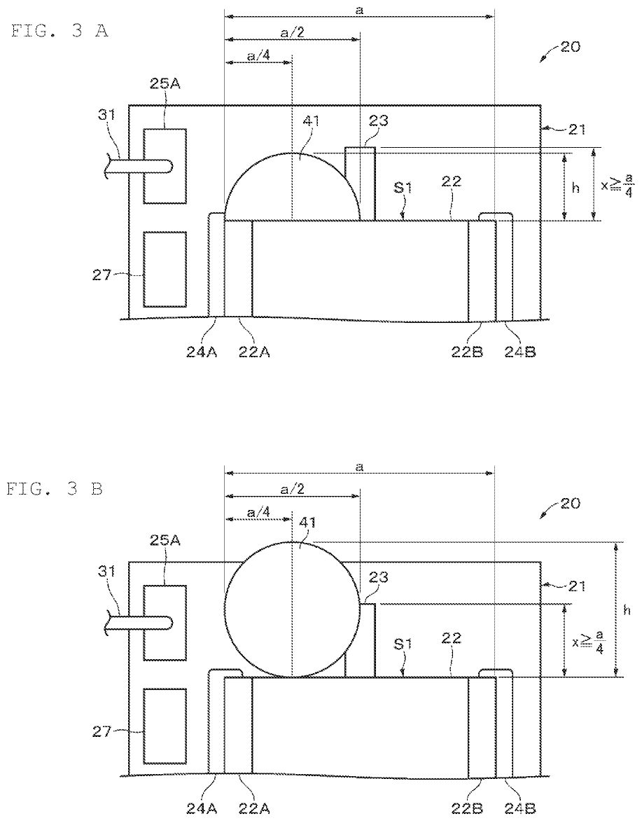

The reason why the length x of the protrusion of the insulator 23 is set to x≥a/4 will be described here with reference to FIG. 3A. However, it is assumed that a contact angle of a water droplet 41 on the side surface S1, S2 of the battery 22 is 90°. When the water droplet 41 adheres to the side surface S1, S2 of the battery 22 under a high-temperature and high-humidity atmosphere or due to dew condensation or the like, surface tension acts on the surface of the water droplet 41 having adhered. Thereby, the water droplet 41 tries to reduce the surface area and becomes hemispherical. Assuming that the water droplet 41 divided into two by the insulator 23 adheres to the half region of the side surface S1, S2, the radius of the water droplet 41 becomes: r=(a/2)/2=a/4. Therefore, when the length x of the protrusion of the insulator 23 and the length a of the battery 22 satisfy the relationship of x≥a/4, the length x of the protrusion of the insulator 23 becomes equal to or greater than a height h of the water droplet 41, and it is thus possible to prevent the water droplet 41 from connecting the positive electrode terminal 22A and the negative electrode terminal 22B. It is thus possible to prevent the occurrence of electric corrosion. For example, when the size of the battery 22 is 10 mm×10 mm, the occurrence of electric corrosion can be prevented so long as the length x of the protrusion of the insulator 23 is 2.5 mm or more.

It should be understood that the contact angle of the water droplet 41 on the surface of a general electronic component (e.g., battery) mounted on the electronic component mounting substrate is generally considered to be 90° or less. Therefore, when the protruding width of the insulator 23 is defined as described above, the occurrence of electric corrosion of the general electronic component can be prevented. However, as illustrated in FIG. 3B, even when the contact angle of the water droplet 41 exceeds 900 on the surface of the electronic component such as the battery 22, it is difficult for the water droplet 41 to get over the insulator 23 so long as the length x of the protrusion of the insulator 23 and the length a of the battery 22 satisfy the relationship of x≥a/4. It is thus possible to prevent the occurrence of electric corrosion of the electronic component such as the battery 22. In FIG. 3B, an instance in which the contact angle of the water droplet 41 is 180°, that is, the water droplet 41 is spherical, is illustrated as an extreme example, but the contact angle of the water droplet 41 exceeding 90° is not limited thereto.

From the viewpoint of further preventing the occurrence of electric corrosion, the length x of the protrusion of the insulator 23 and the length a of the battery 22 preferably satisfy a relationship of x≥a/3, and more preferably satisfy a relationship of x≥a/2. The upper limit value of the length x of the protrusion of the insulator 23 is not particularly limited but is, for example, x≤a.

The insulator 23 includes, for example, at least one of a thermosetting resin and an energy ray-curable resin. The thermosetting resin includes, for example, at least one of an epoxy resin, a phenol resin, an unsaturated polyester, and a melamine resin. The energy ray-curable resin is preferably an ultraviolet ray-curable resin. The ultraviolet ray-curable resin may be either a radical polymerization resin or a cationic polymerization resin. Note that the insulator 23 may be an adhesive or silk.

The insulator 23 may contain a known additive as necessary. For example, the insulator 23 may contain a pigment such as barium sulfate particles or titanium oxide particles. The insulator 23 may also contain at least one of an antistatic agent, a thermal stabilizer, an antioxidant, a dispersant, a flame retardant, a surface modifier (antifoam agent, leveling agent, etc.), a plasticizer, and the like.

As the method for forming the insulator 23, for example, silk printing, inkjet printing, or the like can be used, but the method is not limited to these methods.

The width w of the insulator 23 preferably satisfies the following expression (1):

w≤2×(a/c)×((c/2)−b) (1)

where, as illustrated in FIG. 4A, a is the length of the battery 22 in the direction from the positive electrode terminal 22A toward the negative electrode terminal 22B, b is the thickness of the insulator 23, and c is the thicknesses of solder pastes 24C, 24D before reflow.

By the width w of the insulator 23 satisfying the relationship of the above expression (1), the contact between the positive electrode terminal 22A and the solder paste 24C and the contact between the negative electrode terminal 22B and the solder paste 24D can be ensured even when the battery 22 is placed with an inclination to the one surface of the substrate 21. It is thus possible to prevent the occurrence of a soldering failure.

A process for deriving the expression (1) will be described below. Here, as illustrated in FIG. 4A, an instance in which the battery 22 is placed with an inclination to the one surface of the substrate 21 will be considered. As illustrated in FIG. 4A, when the width w of the insulator 23 is small, the battery 22 is not inclined greatly due to the insulator 23, so that the negative electrode terminal 22B of the battery 22 comes into contact with the upper end of the solder paste 24D. When the contact between the negative electrode terminal 22B and the solder paste 24D is ensured as described above, a soldering failure does not occur. On the other hand, as illustrated in FIG. 4B, when the width w of the insulator 23 is large, the battery 22 is inclined due to the insulator 23, so that the negative electrode terminal 22B of the battery 22 does not come into contact with the upper end of the solder paste 24D. When the contact between the negative electrode terminal 22B and the solder paste 24D is not ensured as described above, a soldering failure occurs. Therefore, for preventing the occurrence of a soldering failure, the width w of the insulator 23 is preferably set within an appropriate range.

As illustrated in FIG. 4C, when an angle formed between the bottom surface of the battery 22 and the one surface of the substrate 21 is θ and the maximum angle θ at which the negative electrode terminal 22B and the solder paste 24D can ensure contact is θₘₐₓ, the occurrence of a soldering failure can be prevented so long as the relationship of the following expression (2) is satisfied:

θ≤θₘₐₓ (2)

When θ and θₘₐₓ are very small (e.g., when a thickness c of each of the solder pastes 24C, 24D is about 0.1 mm.), the expression (2) can be rewritten as an expression (3) below. When a=1 mm, θ is about 6°, and when a=10 mm, θ is about 1°.

tan θ≤tan θₘₐₓ (3)

The expression (3) is represented by the following expression (4) when modified using a, b, and x:

b/((a/2)−x)≤c/a (4).

Solving the expression (3) for x gives the following equation (5):

x≤(a/c)×((c/2)−b) (5)

The above expression (1) is derived by doubling both sides of the expression (5).

The substrate body 211 is a rigid substrate having an insulating property. Specific examples of the substrate body 211 include, but are not limited to, a paper phenol substrate, a paper epoxy substrate, a glass composite substrate, a glass epoxy substrate, a Teflon (registered trademark) substrate, an alumina (ceramics) substrate, a low-temperature co-fired ceramic (LTCC) substrate, a composite substrate, a halogen-free substrate, and the like.

The pads 212A, 212B are formed by patterning a copper foil into a predetermined shape. The solders 24A, 24B are for soldering the positive electrode terminal 22A and the negative electrode terminal 22B to the pads 212A, 212B, respectively. The solders 24A, 24B are, for example, lead-free solders such as solder paste. A cable 31 is electrically connected to each of the plus terminal 25A and the minus terminal 25B.

The resist layer 213 has holes in portions corresponding to the pads 212A, 212B, the plus terminal 25A, the minus terminal 25B, the protection IC 26, and the charge/discharge FET 27, and these portions are exposed from the resist layer 213. The resist layer 213 contains solder resist, protects the pads 212A, 212B made of copper foil, and the like, and prevents unnecessary adhesion of solder during soldering.

The battery 22 is an example of an electronic component, specifically, a bulk-type all-solid-state battery. Specific examples of the all-solid-state battery include an all-solid-state lithium battery, an all-solid-state sodium battery, an all-solid-state potassium battery, an all-solid-state magnesium battery, an all-solid-state calcium battery, and the like, among which the all-solid-state lithium battery is preferred but is not limited thereto. Although a description will be given of an instance in which the battery 22 is a secondary battery, the battery 22 may be a primary battery.

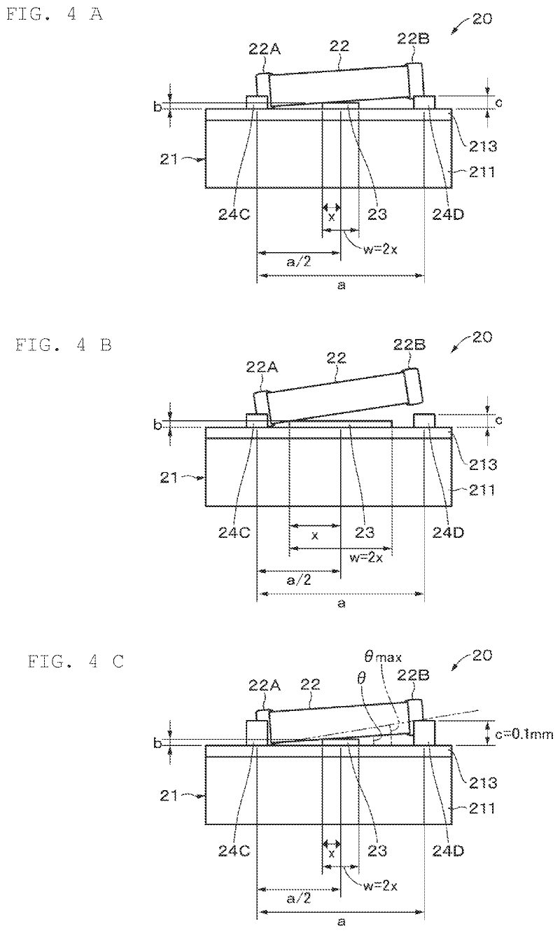

As illustrated in FIG. 5, the battery 22 includes a rectangular thin plate-shaped battery element 220, and the positive electrode terminal 22A and the negative electrode terminal 22B provided on the end surfaces 220SA, 220SB, facing each other, of the battery element 220. The battery 22 may further comprise an external material (not illustrated) that covers the surface of the battery element 220 except for the end surfaces 220SA, 220SB.

The battery element 220 includes a positive electrode layer 221, negative electrode layers 222M, 222N, and a solid electrolyte 223. The negative electrode layer 222M is provided such that one main surface thereof faces the one main surface of the positive electrode layer 221, and the solid electrolyte 223 is provided between the negative electrode layer 222M and the positive electrode layer 221. The negative electrode layer 222N is provided such that one main surface thereof faces the other main surface of the positive electrode layer 221, and the solid electrolyte 223 is provided between the negative electrode layer 222N and the positive electrode layer 221.

The solid electrolyte 223 covers the peripheral surface of the positive electrode layer 221 such that a portion of the peripheral surface of the positive electrode layer 221 is exposed from the end surface 220SA of the battery element 220, while the other portion of the peripheral surface is not exposed from the surface of the battery element 220. A portion of the peripheral surface of the positive electrode layer 221, exposed from the end surface 220SA of the battery element 220, is in contact with the positive electrode terminal 22A.

The solid electrolyte 223 covers the peripheral surfaces of the negative electrode layers 222M, 222N such that a portion of each of the peripheral surfaces of the negative electrode layers 222M, 222N is exposed from the end surface 220SB of the battery element 220, while the other portion of each of the peripheral surfaces is not exposed from the surface of the battery element 220. A portion of each of the peripheral surfaces of the negative electrode layers 222M, 222N, exposed from the end surface 220SB of the battery element 220, is in contact with the negative electrode terminal 22B. The solid electrolyte 223 may cover the other main surfaces of the negative electrode layers 222M, 222N.

The positive electrode layer 221 includes a positive electrode current collector 221A, and a positive electrode active material layer 221B provided on each main surface of the positive electrode current collector 221A. Each of the negative electrode layers 222M, 222N includes a negative electrode current collector 222A and a negative electrode active material layer 222B provided on one main surface of the negative electrode current collector 222A. The negative electrode layers 222M, 222N are provided such that the negative electrode active material layer 222B faces the positive electrode active material layer 2221B.

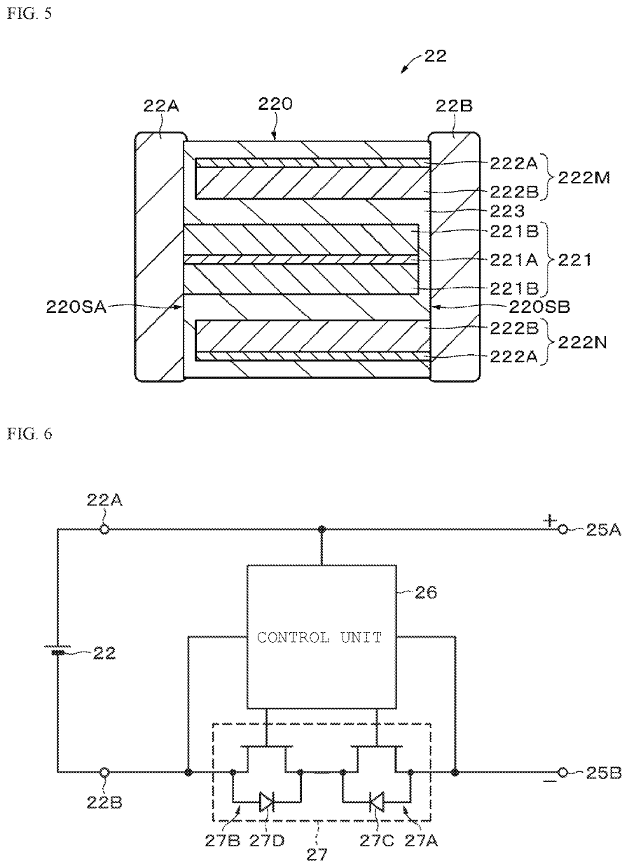

The circuit configuration of the battery pack will be described below with reference to FIG. 6. The positive electrode terminal 22A of the battery 22 is connected to the plus terminal 25A of the substrate 21 by wiring. The negative electrode terminal 22B of the battery 22 is connected to the minus terminal 25B of the substrate 21 by wiring.

A control unit (controller) 26 controls the charge/discharge operation of the battery 22 by controlling the charge/discharge FET 27. By controlling the charge/discharge FET 27, the control unit 26 controls the charge/discharge operation so as to prevent a charge voltage from becoming excessive during charge/discharge, an overcurrent from flowing due to a load short circuit, and over-discharge from occurring.

The charge/discharge FET 27 includes a charge control field-effect transistor (FET) 27A and a discharge control FET 27B. The charge control FET 27A and the discharge control FET 27B are subjected to on-off control on the basis of the control of the control unit 26.

A parasitic diode 27C and a parasitic diode 27D are connected between the drains and the sources of the charge control FET 27A and the discharge control FET 27B, respectively. The parasitic diode 27C has a polarity in a reverse direction to a charging current and in a forward direction to a discharging current. The parasitic diode 27D has a polarity in the forward direction with respect to the charging current and in the reverse direction with respect to the discharging current.

Control signals from the control unit 26 are supplied to the gates of the charge control FET 27A and the discharge control FET 27B, respectively. Each of the charge control FET 27A and the discharge control FET 27B is a P channel type and is turned on by a gate potential that is lower than a source potential by a predetermined value or more. During charge/discharge, the charge control FET 27A and the discharge control FET 27B are in the on state.

An N-channel FET may be used as the charge control FET 27A and the discharge control FET 27B. When the N-channel FET is used, the charge control FET 27A and the discharge control FET 27B are turned on by the gate potential that is higher than the source potential by a predetermined value or more.

The electronic component mounting substrate 20 according to the above one embodiment includes: the substrate 21 having the pads 212A, 212B and the insulator 23 provided between the pads 212A, 212B; and the battery 22 having the positive electrode terminal 22A and the negative electrode terminal 22B respectively connected to the pads 212A, 212B, the battery 22 being provided on the insulator 23. The insulator 23 has a convex shape with respect to one surface of the substrate 21 and protrudes from both side surfaces S1, S2 between the positive electrode terminal 22A and the negative electrode terminal 22B. Further, the length x of the protrusion of the insulator 23 from both side surfaces S1, S2 and the length a of the battery 22 in the direction from the positive electrode terminal 22A toward the negative electrode terminal 22B satisfy the relationship of x≥a/4. Therefore, even when the water droplet 41 adheres to the side surface S1, S2 of the battery 22 under a high-temperature and high-humidity atmosphere or due to dew condensation or the like, the length x of the protrusion of the insulator 23 becomes equal to or greater than the height h of the water droplet 41. As a result, it is possible to prevent the water droplet 41 from connecting between the positive electrode terminal 22A and the negative electrode terminal 22B or between the pads 212A, 212B. It is thus possible to prevent the occurrence of electric corrosion.

Further, with the insulator 23 being also present between the one surface of the substrate 21 and the rear surface of the battery 22, even when the water droplet 41 gets to the rear surface of the battery 22, it is possible to prevent the water droplet 41 from connecting between the positive electrode terminal 22A and the negative electrode terminal 22B or between the pads 212A, 212B. It is thus possible to prevent the occurrence of electric corrosion.

Although the instance in which the substrate 21 is a single-sided substrate has been described in the above one embodiment, the type of the substrate is not limited thereto but may be a double-sided substrate, a multilayer substrate, a build-up substrate, or the like. When the substrate 21 is a double-sided substrate, the battery 22 may be provided on both surfaces, or the battery 22 may be provided on one surface.

Although the instance in which the substrate body 211 is a rigid substrate has been described in the above one embodiment, the type of the substrate body 211 is not limited thereto but may be a flexible substrate, a rigid flexible substrate, or the like.

Although the instance in which the substrate 21 is flat has been described in the above one embodiment, the shape of the substrate 21 is not limited thereto, but the substrate 21 may be curved or bent.

Although the instance in which the exterior material is the exterior case 10 has been described in the above one embodiment, the exterior material is not limited thereto but may be a laminate film or the like.

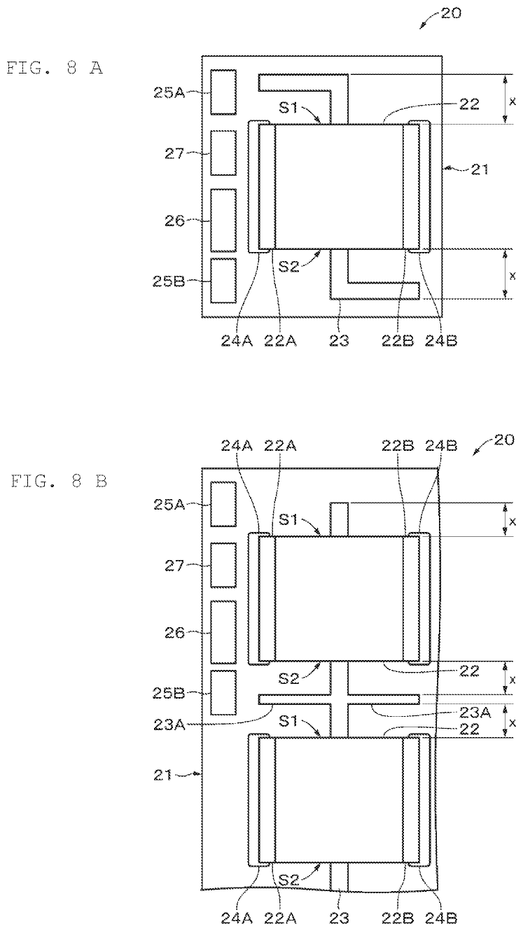

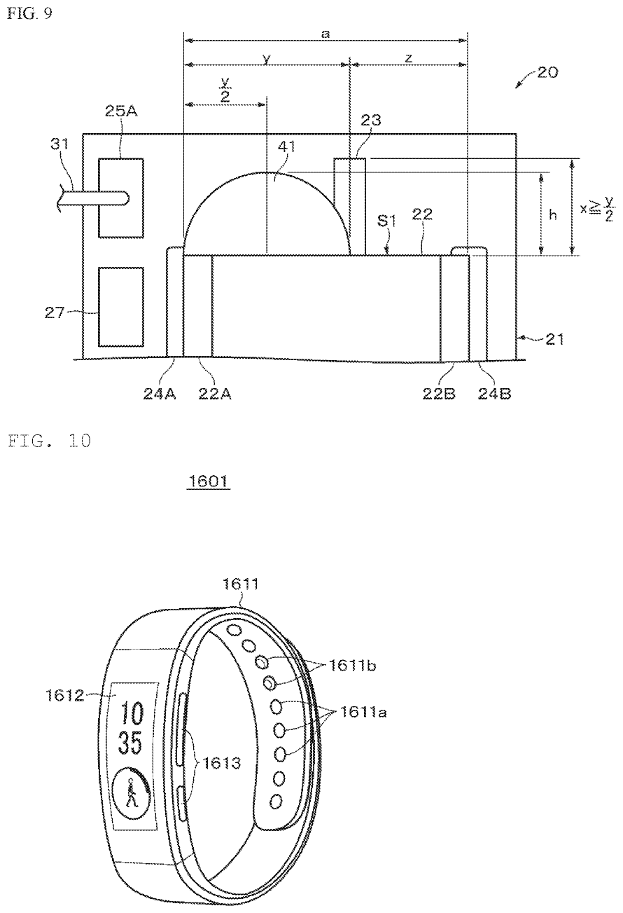

Although the instance in which the electronic component mounting substrate 20 includes one battery 22 has been described in the above one embodiment, a plurality of batteries 22 may be provided as illustrated in FIG. 8B. The plurality of batteries 22 may form one or more rows such that the side surfaces S1, S2 of the plurality of batteries face each other. In this instance, when the electronic component mounting substrate 20 is seen in a plan view from a direction perpendicular to the one surface on which the batteries 22 are mounted, as illustrated in FIG. 8B, one insulator 23 may be provided so as to penetrate the plurality of batteries 22 formed in one row. However, the configuration of the insulator 23 is not limited thereto, but the substrate 21 may have a plurality of insulators 23 that are provided corresponding to the plurality of batteries 22, respectively.

In the above one embodiment, the instance in which the battery 22 is a thin plate has been described, but the shape of the battery 22 is not limited thereto but may be a sheet shape, a block shape, or the like.

Although the instance in which the main surface of the battery 22 is rectangular has been described in the above one embodiment, the shape of the main surface of the battery 22 is not limited thereto but may be circular, elliptical, polygonal except for square, indefinite, or the like.

In the above one embodiment, the instance in which the electronic component is the battery 22 has been described, but the type of the electronic component is not limited thereto, but an electronic component having at least two terminals connected to the substrate 21 can be used. Specific examples of the electronic components except for the battery 22 include, but are not limited to, a capacitor, a resistor, a coil, a diode, a transistor, a switch, and the like.

In the above one embodiment, the instance in which both ends of the insulator 23 protrude from both side surfaces S, S2 of the battery 22 has been described, but one end of the insulator 23 may protrude from either side surface S1 or S2 of the battery 22.

In the above one embodiment, the instance in which the insulator 23 is also present between the one surface of the substrate 21 and the rear surface of the battery 22 has been described, but the insulator 23 may not be present between the one surface of the substrate 21 and the rear surface of the battery 22. However, in order to also prevent the occurrence of electric corrosion when the water droplet 41 gets to the rear surface of the battery 22, it is preferable that the insulator 23 be also present between the one surface of the substrate 21 and the rear surface of the battery 22 as in the above one embodiment.

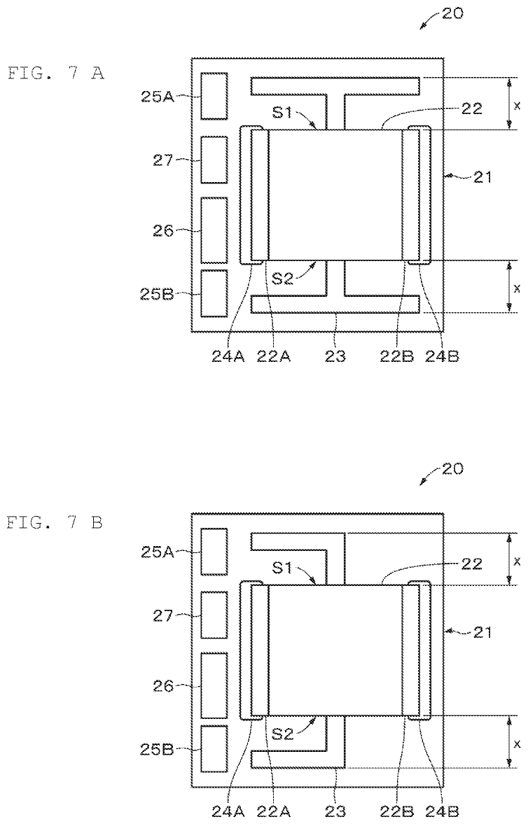

In the above one embodiment, the instance in which the insulator 23 has a linear shape has been described, but the shape of the insulator 23 is not limited thereto. For example, as illustrated in FIG. 7A, the tip of the insulator 23 protruding from each of the side surfaces S, S2 may be branched into a T-shape. As illustrated in FIG. 7B, the tip of the insulator 23 protruding from the side surface S1 may be bent at a right angle to form an L-shape, and the tip of the insulator 23 protruding from the side surface S2 may be bent at a right angle to form an inverted L-shape. The bending direction of the tip of the insulator 23 is not limited to the same direction as illustrated in FIG. 7B, but may be the opposite direction as illustrated in FIG. 8A. Further, the insulator 23 may be made thicker or thinner toward the tip. The insulator 23 may also have a serpentine shape such as a sinusoidal or serrated shape. When the insulator 23 is formed in the shape described above, the length x of the protrusion of the insulator 23 means the length of the portion extended perpendicularly from each of the side surfaces S1, S2.

In addition, as illustrated in FIG. 8B, when the plurality of batteries 22 are arranged in a row such that the side surfaces S1, S2 face each other, the insulator 23 may have a linear extended portion 23A extended in a direction from the positive electrode terminal 22A toward the negative electrode terminal 22B between the batteries 22 adjacent in the column direction. In this instance, a water droplet is divided between the side surfaces S1, S2 of the two batteries 22 adjacent in the column direction by the extended portion 23A, so that it is possible to prevent the water droplet from connecting between the positive electrode terminals 21A or between the negative electrode terminal 21B of the adjacent batteries 22. Therefore, when there is a potential difference between the positive electrode terminals 21A or between the negative electrode terminals 21B of the two adjacent batteries 22, it is possible to prevent the occurrence of electric corrosion between the two adjacent batteries 22. Note that the potential difference between the positive electrode terminals 21A or between the negative electrode terminals 21B of the two adjacent batteries 22 may be caused not only by the configuration of the two adjacent batteries 22 being different but also by factors such as the state of charge/discharge and the state of deterioration of the two adjacent batteries 22. In the two batteries 22 adjacent in the column direction, the positive electrode terminal 21A and the negative electrode terminal 22B may be opposed to each other. The configuration in which the extended portion 23A is provided is particularly effective when the positive electrode terminal 21A and the negative electrode terminal 22B face each other as described above.

Although the instance in which the protruding position of the insulator 23 is the center position of the side surfaces S1, S2 has been described, as illustrated in FIG. 9, the protruding position of the insulator 23 may be shifted from the center position of the side surfaces S1, S2. In this instance, a length x of the protrusion of the insulator 23 from the side surface S1, S2, and a longer distance y between a distance z from a first end of the side surface S1, S2 to the position of the protrusion of the insulator 23 and a distance z from a second end of the side surface S1, S2 to the position of the protrusion of the insulator 23 satisfy the relationship x≥y/2. Thus, even when the water droplet 41 adheres to the side surfaces S1, S2 of the battery 22 under a high-temperature and high-humidity atmosphere or due to dew condensation or the like, it is possible to prevent the water droplet 41 from connecting between the positive electrode terminal 22A and the negative electrode terminal 22B or between the pads 212A, 212B. It is thus possible to prevent the occurrence of electric corrosion.

Applications of the present invention to a wristband electronic device will be described below.

A wristband electronic device, also called a smart band, can acquire data on a person's activities such as the number of steps taken, distance traveled, calories burned, amount of sleep, and heart rate by simply wrapping it around the arm. The smartphone can also manage the acquired data. Further, the smartphone can be provided with a function of sending and receiving a mail and can, for example, notify a user of the arrival of a mail by using a light-emitting diode (LED) lamp and/or vibration.

FIG. 10 illustrates the appearance of a wristband electronic device 1601. The electronic device 1601 is a wearable device in the form of a watch that can be worn on and removed from the human body. The electronic device 1601 is provided with a band portion 1611 to be put on the arm, a display 1612 for displaying numbers, letters, patterns, and the like, and an operation button 1613. The band portion 1611 is formed with a plurality of holes 1611a and a projection 1611b provided on the inner peripheral surface (the side of the surface that comes into contact with the arm when the electronic device 1601 is put on).

When the electronic device 1601 is in use, as illustrated in FIG. 10, the band portion 1611 is curved into a substantially circular shape, the projection 1611b is inserted into the hole 1611a, and the electronic device 1601 is put on the arm. By adjusting the position of the hole 1611a into which the projection 1611b is inserted, the size of the diameter can be adjusted corresponding to the width of the arm. When the electronic device 1601 is not in use, the projection 1611b is removed from the hole 1611a, and the electronic device 1601 is stored with the band portion 1611 in a substantially flat state. Inside the band portion 1611, a sensor (not illustrated) is provided almost over the entire band portion 1611.

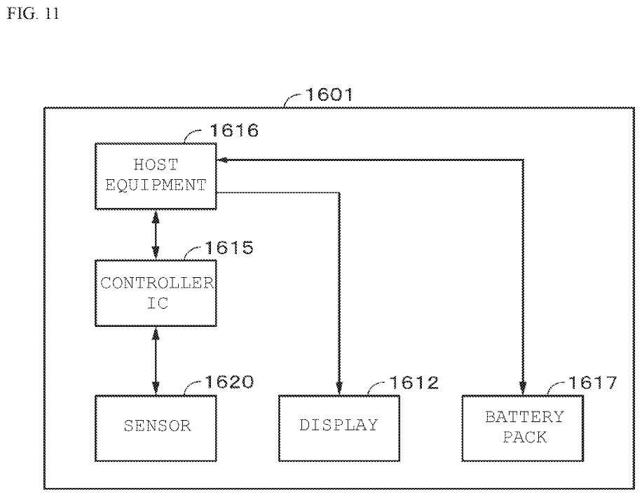

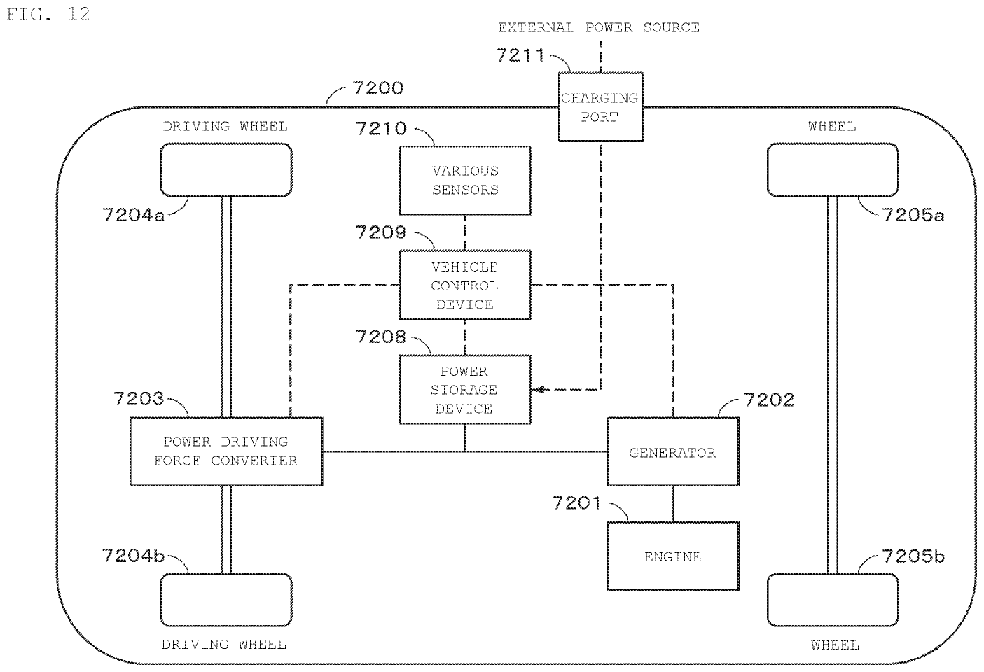

FIG. 11 illustrates the configuration of the electronic device 1601. The electronic device 1601 includes, in addition to the display 1612 described above, a controller IC 1615 as a drive control unit, a sensor 1620, host equipment 1616, and a battery pack 1617 as a power source. The sensor 1620 may include the controller IC 1615.

The sensor 1620 can detect both pressing and bending. The sensor 1620 detects a change in capacitance in response to pressing and outputs an output signal corresponding to the detected change to the controller IC 1615 Further, the sensor 1620 detects a change in value of resistance in response to the bending (resistance change) and outputs an output signal corresponding thereto to the controller IC 1615. The controller IC 1615 detects the pressing and bending in the sensor 1620 on the basis of the output signals from the sensor 1620 and outputs information corresponding to the detection result to the host equipment 1616.

The host equipment 1616 executes various processing on the basis of the information supplied from the controller IC 1615. For example, processing such as display of character information, image information, and the like on the display 1612, movement of a cursor displayed on the display 1612, and scrolling of a screen, is executed.

The display 1612 is, for example, a flexible display, and displays a screen on the basis of a video signal, a control signal, and the like supplied from the host equipment 1616. Examples of the display 1612 include, but are not limited to, a liquid crystal display, an electroluminescence (EL) display, electronic paper, and the like.

The battery pack 1617 is a battery pack according to the above one embodiment or its modification. In place of the battery pack 1617, the electronic device 1601 may include the electronic component mounting substrate 20 according to the above one embodiment or its modification.

The present invention is applicable to various electronic devices provided with batteries and is not limited to the wristband electronic device 1601 described in the above application. Examples of the electronic devices except for the above application include, but are not limited to, a notebook personal computer, a tablet computer, a mobile phone (e.g., smartphone), a personal digital assistant (PDA), a display (liquid crystal display (LCD), EL display, electronic paper, etc.), an imaging device (e.g., digital still camera, digital video camera, etc.), an audio device (e.g., portable audio player), a game device, a universal credit card, a sensor network terminal, a smart watch, an eyeglass terminal (head-mounted display (HMD), etc.), a cordless phone handset, an electronic book, an electronic dictionary, a radio, a headphone, a navigation system, a memory card, a pacemaker, a hearing aid, a power tool, an electric shaver, a refrigerator, an air conditioner, a television, a stereo, a water heater, a microwave oven, a dishwasher, a washing machine, a dryer, a lighting device, a toy, a medical device, a robot, a load conditioner, a signal, and the like.

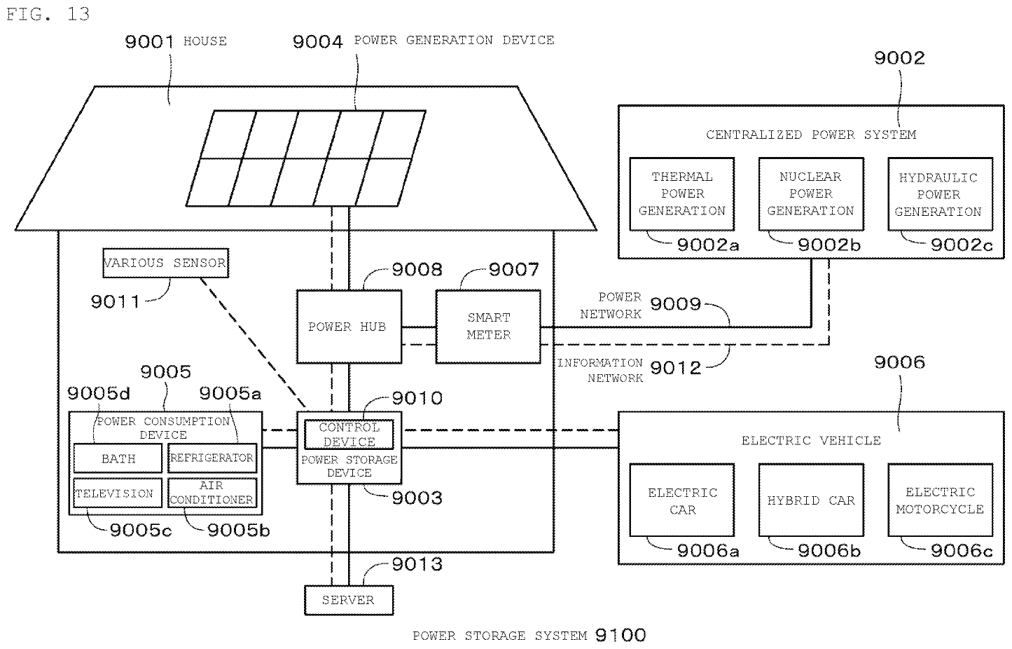

An example of applying the present invention to a power storage system for a vehicle will be described with reference to FIG. 12. FIG. 12 schematically illustrates a configuration of a hybrid vehicle employing a series hybrid system to which the present invention is applied. A series hybrid system is a vehicle that travels with a power driving force converter using electric power generated by an engine-driven generator or electric power temporarily stored in a battery.

This hybrid vehicle 7200 is mounted with an engine 7201, a generator 7202, a power driving force converter 7203, a driving wheel 7204a, a driving wheel 7204b, a wheel 7205a, a wheel 7205b, a power storage device 7208, a vehicle control device 7209, various sensors 7210, and a charging port 7211. The power storage device 7208 includes the electronic component mounting substrate 20 in any of the above one embodiment and its modifications.

The hybrid vehicle 7200 travels using the power driving force converter 7203 as a power source. An example of the power driving force converter 7203 is a motor. The electric power of the power storage device 7208 operates the power driving force converter 7203, and the rotating force of the power driving force converter 7203 is transmitted to the driving wheels 7204a, 7204b. By using direct current-alternate current (DC-AC) conversion or inverse conversion (AC-DC conversion) where necessary, the power driving force converter 7203 can be applied to an AC motor or a DC motor. The various sensors 7210 control the engine speed via the vehicle control device 7209 and control the opening degree (throttle opening degree) of a throttle valve, not illustrated. The various sensors 7210 include a speed sensor, an acceleration sensor, an engine speed sensor, and the like.

The rotating force of the engine 7201 is transmitted to the generator 7202, and the electric power generated by the generator 7202 by the rotating force can be stored into the power storage device 7208.

When the hybrid vehicle is decelerated by a braking mechanism (not illustrated), a resistance force at the time of deceleration is applied to the power driving force converter 7203 as a rotating force, and regenerative power generated by the power driving force converter 7203 by the rotating force is stored into the power storage device 7208.

By being connected to an external power source of the hybrid vehicle, the power storage device 7208 can receive electric power supply from the external power source with the charging port 7211 as an input port and store the received electric power.

Although not illustrated, an information processing device may be provided which performs information processing concerning vehicle control on the basis of information on the secondary battery. Such an information processing device includes, for example, an information processing device for displaying a remaining battery amount on the basis of information on the remaining battery amount.

In the above, the description has been given of, as an example, the series hybrid car that travels with the motor using the electric power generated by the engine-driven generator, or the electric power temporarily stored in the battery. However, the present invention is also effectively applicable to a parallel hybrid vehicle in which the outputs of the engine and the motor serve as drive sources, and three systems of traveling only with the engine, traveling only with the motor, and traveling with the engine and the motor are appropriately switched and used. Further, the present invention can be effectively applied to a so-called electric vehicle that travels by driving only by a driving motor without using an engine.

An example of the hybrid vehicle 7200 to which the technology according to the present invention can be applied has been described above. The technique according to the present invention can be suitably applied to the power storage device 7208 among the configurations described above.

An example in which the present invention is applied to a power storage system for a house will be described with reference to FIG. 13. For example, in a power storage system 9100 for a house 9001, electric power is supplied from a centralized power system 9002 such as a thermal power generation 9002a, a nuclear power generation 9002b, and a hydraulic power generation 9002c, to a power storage device 9003 via a power network 9009, an information network 9012, a smart meter 9007, a power hub 9008, and the like. Along with this, electric power is supplied to the power storage device 9003 from an independent power source such as a power generation device 9004 in the home. The electric power supplied to the power storage device 9003 is stored. Electric power to be used in the house 9001 is supplied using the power storage device 9003. A similar power storage system can be used not only for the house 9001 but also for the building.

The house 9001 is provided with a power generation device 9004, a power consumption device 9005, the power storage device 9003, a control device 9010 for controlling each device, the smart meter 9007, and a sensor 9011 for acquiring various kinds of information. Each device is connected by the power network 9009 and the information network 9012. A solar cell, a fuel cell, or the like is used as the power generation device 9004, and the generated electric power is supplied to the power consumption device 9005 and/or the power storage device 9003. The power consumption device 9005 is a refrigerator 9005a, an air conditioner 9005b, a television receiver 9005c, a bath 9005d, and the like. Further, the power consumption device 9005 includes an electric vehicle 9006. The electric vehicle 9006 is an electric car 9006a, a hybrid car 9006b, and an electric motorcycle 9006c.

The power storage device 9003 includes an electronic component mounting substrate 20 in any of the above one embodiment and its modifications. The smart meter 9007 has a function of measuring the usage quantity of commercial power and transmitting the measured usage quantity to an electric power company. The power network 9009 may be any one or a combination of DC power supply, AC power supply, and non-contact power supply.

The various sensors 9011 are, for example, a human sensor, an illuminance sensor, an object detection sensor, a power consumption sensor, a vibration sensor, a contact sensor, a temperature sensor, an infrared sensor, and the like. The information acquired by each of the various sensors 9011 is transmitted to the control device 9010. With the information from the sensor 9011, a weather condition, a human condition, and the like are grasped, and the power consumption device 9005 can be automatically controlled to minimize energy consumption. Further, the control device 9010 can transmit information on the house 9001 to an external electric power company or the like via the Internet.

The power hub 9008 performs processing such as branching of a power line and DC/AC conversion. As a communication method of the information network 9012 connected to the control device 9010, there are a method using a communication interface such as universal asynchronous receiver-transmitter (UART): transmission/reception circuit for asynchronous serial communication), and a method using a sensor network based on a wireless communication standard such as Bluetooth (registered trademark), ZigBee (registered trademark), or Wi-Fi. The Bluetooth (registered trademark) system is applied to multimedia communication and can perform one-to-many connection communication. ZigBee (registered trademark) uses the physical layer of the Institute of Electrical and Electronics Engineers (IEEE) 802.15.4. IEEE 802.15.4 is the name of a short-range wireless network standard called personal area network (PAN) or wireless (W) PAN.

The control device 9010 is connected to an external server 9013. The server 9013 may be managed by any of the house 9001, the electric power company, or a service provider. The information transmitted and received by the server 9013 is, for example, power consumption information, life pattern information, a power charge, weather information, natural disaster information, and information on power trading. These pieces of information may be transmitted and received from a power consumption device (e.g., television receiver) in the home, but may be transmitted and received from a device outside the home (e.g., mobile phone, etc.). These pieces of information may be displayed on equipment having a display function, such as a television receiver, a mobile phone, or a personal digital assistant (PDA).

The control device 9010 for controlling each unit is made up of a central processing unit (CPU), a random access memory (RAM), a read only memory (ROM), and the like and is stored in the power storage device 9003 in this example. The control device 9010 is connected to the power storage device 9003, the power generation device 9004 in the home, the power consumption device 9005, various sensors 9011, and the server 9013 through the information network 9012, and has a function of adjusting, for example, the amount of commercial power used and the amount of power generated. In addition to the above, the control device 9010 may be provided with a function for conducting power trading in the electric power market.

As described above, not only the electric power generated by not only the centralized power system 9002 such as the electric power is generated by the thermal power generation 9002a, the nuclear power generation 9002b, the hydraulic power generation 9002c, or the like, but also the electric power generated by the power generation device 9004 (solar power generation, wind power generation) in the home can be stored into the power storage device 9003. Therefore, even when the electric power of the power generation device 9004 in the home fluctuates, it is possible to perform control of making constant the amount of electric power to be sent out to the outside and discharging as much as necessary. For example, it is possible to store the electric power obtained by solar power generation into the power storage device 9003, store midnight electric power which is inexpensive at night into the power storage device 9003, and discharge to use the electric power stored by the power storage device 9003 during a time period when the daytime charge is high.

Although the example in which the control device 9010 is stored into the power storage device 9003 has been described in this example, the control device 9010 may be stored into the smart meter 9007 or may be configured alone. Further, the power storage system 9100 may be used for a plurality of homes in a collective housing or may be used for a plurality of detached houses.

While the embodiment of the present invention and its modifications have been specifically described above, the present invention is not limited to the above embodiment and its modifications, but various modifications based on the technical idea of the present invention are possible.

For example, the configurations, methods, processes, shapes, materials, numerical values, and the like mentioned in the above-described embodiment and its modifications are merely examples, and different configurations, methods, processes, shapes, materials, numerical values and the like from these may be used as necessary.

Also, the configurations, methods, processes, shapes, materials, numerical values, and the like of the above embodiment and its modifications can be combined with each other so long as not deviating from the gist of the present invention.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electronic component mounting substrate comprising:
a substrate having a first substrate terminal, a second substrate terminal, and an insulator provided between the first substrate terminal and the second substrate terminal; and
an electronic component having a first terminal configured to be connected to the first substrate terminal and a second terminal configured to be connected to the second substrate terminal, the electronic component being provided on the insulator, wherein
the insulator is provided on a surface of the substrate and has a protrusion configured to protrude from peripheral portions between the first terminal and the second terminal on a periphery of the electronic component, and
a length x of the protrusion of the insulator from each of the peripheral portions and a length a of the electronic component in a direction from the first terminal toward the second terminal satisfy a relationship of x≥a/4.

2. The electronic component mounting substrate according to claim 1, wherein the electronic component includes an all-solid-state battery.

3. The electronic component mounting substrate according to claim 1, wherein
the substrate includes
a first solder that solders the first terminal to the first substrate terminal, and
a second solder that solders the second terminal to the second substrate terminal, and
a width w of the insulator satisfies a relationship of a formula (1):
w≤2×(a/c)×((c/2)−b) (1)
wherein a is a length of the electronic component in the direction from the first terminal toward the second terminal, b is a thickness of the insulator, and c is a thickness of each of the first solder and the second solder before reflow.

4. The electronic component mounting substrate according to claim 1, wherein
the substrate has
a plurality of the first substrate terminals, and
a plurality of the second substrate terminals,
a plurality of the electronic components are provided on the insulator such that the peripheral portions face each other, and
the insulator has an extended portion extended in the direction from the first terminal toward the second terminal, and the extended portion is between the electronic components adjacent to each other.

5. An electronic component mounting substrate comprising:
a substrate having a first substrate terminal, a second substrate terminal, and an insulator provided between the first substrate terminal and the second substrate terminal; and
an electronic component having a first terminal configured to be connected to the first substrate terminal and a second terminal configured to be connected to the second substrate terminal, the electronic component being provided on the insulator, wherein
the insulator is provided on a surface of the substrate and has a protrusion configured to protrude from peripheral portions between the first terminal and the second terminal on a periphery of the electronic component, and
a length x of the protrusion of the insulator from each of the peripheral portions and a distance y satisfy a relationship of x≥y/2,
wherein the distance y is a longer distance between a distance from a first end of the peripheral portion to a position of the protrusion of the insulator and a distance from a second end of the peripheral portion to the position of the protrusion of the insulator.

6. A battery pack comprising the electronic component mounting substrate according to claim 1.

7. A battery pack comprising the electronic component mounting substrate according to claim 5.

8. An electronic device comprising the electronic component mounting substrate according to claim 1.

9. An electronic device comprising the electronic component mounting substrate according to claim 5.

10. An electric vehicle comprising the electronic component mounting substrate according to claim 1.

11. An electric vehicle comprising the electronic component mounting substrate according to claim 5.

12. The electronic component mounting substrate according to claim 1, wherein the insulator has a convex shape with respect to the surface of the substrate.
